(19) United States
(12) Patent Application Publication
(10) Pub. No.: US 2012/0162035 A1
(43) Pub. Date: Jun. 28, 2012

(54) ALL-IN-ONE MULTI-BAND ANTENNA FOR WIRELESS COMMUNICATION SYSTEM

(75) Inventors: Young-Bae JUNG, Daejeon (KR); Soon-Young Eom, Daejeon (KR); Soon-Ik Jeon, Daejeon (KR); Jae-Ick Choi, Daejeon (KR); Chang-Joo Kim, Daejeon (KR)

(73) Assignee: ELECTRONICS AND TELECOMMUNICATIONS RESEARCH INSTITUTE, Daejeon (KR)

(21) Appl. No.: 13/020,373

(22) Filed: Feb. 3, 2011

(30) Foreign Application Priority Data
Dec. 28, 2010 (KR) 10-2010-0136470

(51) Int. Cl. H01Q 21/30

(52) U.S. Cl. 343/727; 343/876; 343/893

(57) ABSTRACT

An all-in-one multi-band antenna includes: a first antenna element configured to operate at a first frequency band, the first antenna element including a first ground, a first radiating part, and a first feed line and a first feed point through which a signal power is applied to the first radiating part; and a second antenna element configured to operate at a second frequency band, the second antenna element including a second ground, a second radiating part, and a second feed line and a second feed point through which a signal power is applied to the second radiating part, wherein the second radiating part is provided within a pseudo-cavity formed at a center portion of the first radiating part.

### CROSS-REFERENCE(S) TO RELATED APPLICATIONS

The present application claims priority of Korean Patent Application No. 10-2010-0136470, filed on Dec. 28, 2010, which is incorporated herein by reference in its entirety.

### BACKGROUND OF THE INVENTION

1. Field of the Invention

Exemplary embodiments of the present invention relate to an all-in-one antenna which is operable at multi frequency bands; and, more particularly, to an all-in-one multi-band antenna for a wireless communication system, which can be miniaturized and operable at multi frequency bands by integrating individual element antennas operating at different frequencies.

2. Description of Related Art

Antennas are one of important components in wireless communications. As the broadband wireless communication technologies have been studied, diverse research and development has been made to improve the performance of antennas.

In general, antennas for communication and broadcast services have been developed to enable one radiating element antenna to provide a two-band service.

In addition, a conventional antenna has been designed so that antenna elements operating at individual frequency bands are positioned on the same ground plate by using a difference of size. Accordingly, the conventional antenna does not substantially have an all-in-one structure. For this reason, it is difficult to miniaturize the conventional antenna. Furthermore, since the conventional technology provides only a dual-band service, more diverse services cannot be provided at the same time under the present circumstances in which diverse communication and broadcast services exist.

Moreover, since the conventional antenna is implemented with only radiating elements, it has a structural limitation that operating frequencies or services cannot be selected or provided actively according to communication environment.

### SUMMARY OF THE INVENTION

An embodiment of the present invention is directed to an all-in-one multi-band antenna for a wireless communication system, which can be miniaturized and operable at multi frequency bands by integrating individual element antennas which operate at different frequencies.

Another embodiment of the present invention is directed to an all-in-one multi-band antenna which is designed to selectively provide a required frequency band among multi frequency bands, thereby improving the operating efficiency of communication facilities.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an all-in-one multi-band antenna includes: a first antenna element configured to operate at a first frequency band, the first antenna element including a first ground, a first radiating part, and a first feed line and a first feed point through which a signal power is applied to the first radiating part; and a second antenna element configured to operate at a second frequency band, the second antenna element including a second ground, a second radiating part, and a second feed line and a second feed point through which a signal power is applied to the second radiating part, wherein the second radiating part is provided within a pseudo-cavity formed at a center portion of the first radiating part.

The all-in-one multi-band antenna may further include a third antenna element disposed on the first radiating part and configured to operate at a third frequency band, the third antenna element including a third radiating part, and a third feed line and a third feed point through which a signal power is applied to the third radiating part.

The all-in-one multi-band antenna may further include a reconfiguration circuit configured to select any one of the first to third radiating parts according to frequency bands of transmit/receive signals.

The third antenna element may include a plurality of third radiating parts, a plurality of third feed lines, and a plurality of feed points corresponding to the third radiating parts.

The third antenna element may use the first radiating part as a ground of the third radiating part.

The plurality of third radiating parts may be disposed on the first radiating part so that the second radiating part is positioned within the inside thereof.

The reconfiguration circuit may include: a first switching element configured to select a path of the transmit signal; a second switching element configured to select a path of the receive signal; and a switch control unit configured to control the first switching element and the second switching element according to the frequency bands of the transmit/receive signals.

The third radiating part may be configured with a dipole radiating element which is printed on a dielectric panel made of a dielectric material.

In accordance with another embodiment of the present invention, an all-in-one multi-band antenna includes: a first antenna element configured to operate at a first frequency band, the first antenna element including a first ground, a first radiating part, and a first feed line and a first feed point through which a signal power is applied to the first radiating part; and second antenna element configured to operate at a second frequency band, the second antenna element including a second radiating part, and a second feed line and a second feed point through which a signal power is applied to the second radiating part, wherein the second radiating part is provided on the first radiating part.

### BRIEF DESCRIPTION OF THE DRAWINGS

FIG. 1 is a configuration diagram of an all-in-one dual-band antenna in accordance with an embodiment of the present invention.

FIG. 2 is a configuration diagram of an all-in-one triple-band antenna in accordance with an embodiment of the present invention.

FIG. 3 illustrates the structure of a third radiating part in the all-in-one triple-band antenna in accordance with the embodiment of the present invention.

FIG. 4 illustrates a reconfiguration circuit of the all-in-one triple-band antenna in accordance with an embodiment of the present invention.

FIG. 5 is a graph showing return loss characteristic at a first frequency band in the all-in-one multi-band antenna in accordance with the embodiment of the present invention.

FIG. 6 is a graph showing return loss characteristic at a second frequency band in the all-in-one multi-band antenna in accordance with the embodiment of the present invention.

FIG. 7 is a graph showing return loss characteristic at a third frequency band in the all-in-one multi-band antenna in accordance with the embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

It is assumed in the following description that a first frequency band includes a cellular service band, a second frequency band includes a WCDMA or WiBro service band, and a third frequency band includes a WiMAX service band.

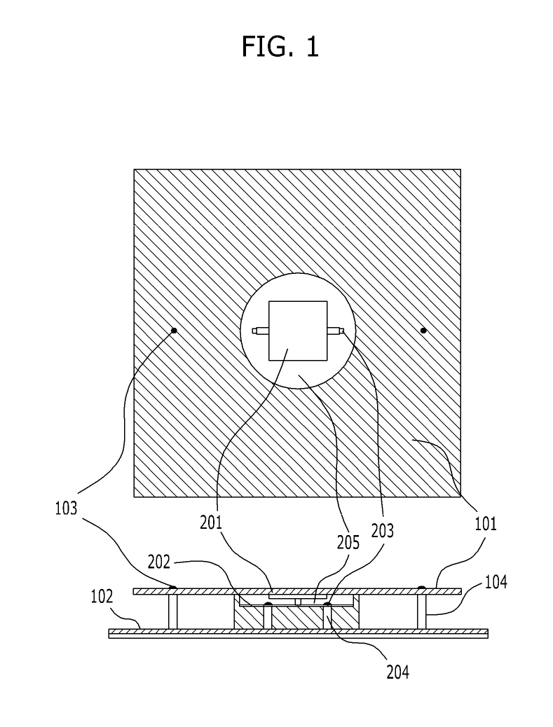

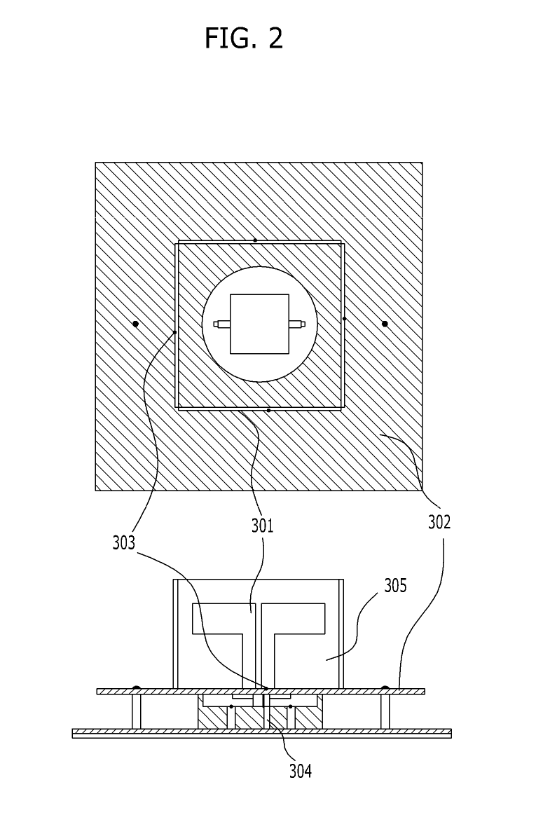

FIG. 1 illustrates a plan view and a cross-sectional view of an all-in-one antenna operating at a dual band in accordance with an embodiment of the present invention. The all-in-one dual-band antenna illustrated in FIG. 1 can also be equally applied to an all-in-one triple-band antenna which will be described later with reference to FIG. 2.

Referring to FIG. 1, an all-in-one multi-band antenna operating at two frequency bands in accordance with an embodiment of the present invention includes a first frequency band radiating part 101 (hereinafter, referred to as a first radiating part) and a second frequency band radiating part 201 (hereinafter, referred to as a second radiating part).

The first radiating part 101 is configured together with a ground 102 thereof. The first radiating part 101 and the ground 102 thereof are disposed to be spaced apart by a predetermined distance. A signal power is applied to the first radiating part 101 through a feed line 104 and a feed point 103 thereof.

The second radiating part 201 is disposed within a pseudo-cavity 205 which is formed by recessing the center portion of the first radiating part 101 by a predetermined depth. In other words, the pseudo-cavity 205 is formed by forming a groove having a predetermined diameter at the center portion of the first radiating part 101. The second radiating part 201 is provided within the pseudo-cavity 205.

Referring to FIG. 1, the second radiating part 201 having a rectangular shape is provided within the pseudo-cavity 205, and a ground 202 of the second radiating part 201 is provided within the pseudo-cavity 205 such that it is spaced part from the second radiating part 201 by a predetermined distance. A signal power is applied to the second radiating part 201 through a feed line 204 and a feed point 203 thereof.

In general, RF radiation occurs around the edges of the radiating part and the signal power is not almost transmitted to the central portion thereof. Thus, the function of the first radiating part 101 is not affected by the pseudo-cavity which is formed with a predetermined diameter at the center portion of the first radiating part 101.

FIG. 2 illustrates a plan view and a cross-sectional view of an all-in-one antenna operating at a triple band in accordance with an embodiment of the present invention.

The all-in-one triple-band antenna illustrated in FIG. 2 is characterized in that a new radiating part operable at a third frequency band is added to the all-in-one dual-band antenna illustrated in FIG. 1.

A third frequency band radiating part 301 (hereinafter, referred to as a third radiating part) is installed on the first radiating part 101. Accordingly, the first radiating part 101 serves as a ground of the third radiating part 301.

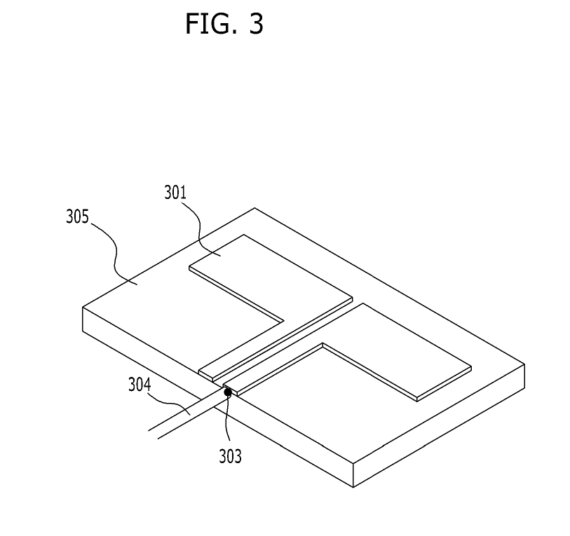

FIG. 3 illustrates the structure of the third radiating part 301 in the all-in-one triple-band antenna in accordance with the embodiment of the present invention.

Referring to FIG. 3, the third radiating part 301 is configured with a radiating element which is printed on a dielectric panel made of a dielectric material. The radiating element is coupled to one end of a feed line 304 of the third radiating part 301 through a feed point 303 thereof.

Referring again to FIG. 2, the antenna for the third frequency band is configured so that the third radiating part 301 provided with four printed dipole antennas is arranged vertically on the top surface of the first radiating part 101 in a rectangular shape. In this case, the second radiating part 201 is disposed within the rectangle defined by the third radiating part 301.

The feed line 304 of the third radiating part 301 is coupled to each of the four printed dipole antennas through the feed point 303 of the third radiating part 301.

Accordingly, the first radiating part 101 serves as the ground of the third radiating part 301. A signal power is applied to the third radiating part 301 through the feed line 304 and the feed point 303 thereof.

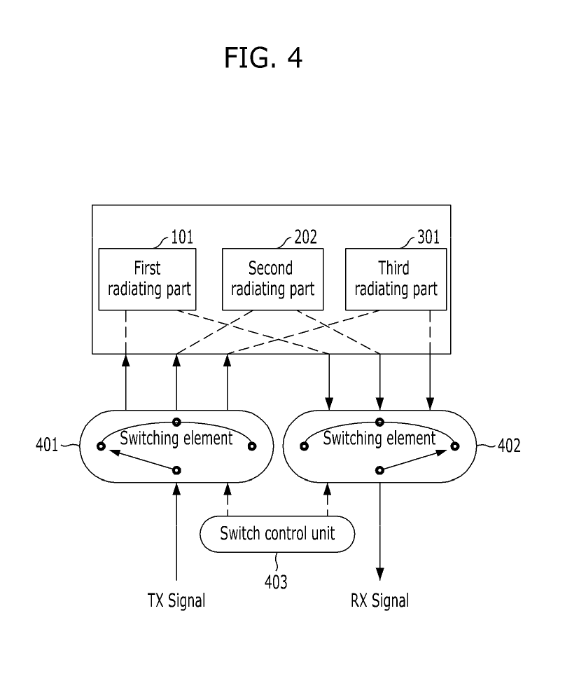

FIG. 4 illustrates a reconfiguration circuit of the all-in-one triple-band antenna in accordance with an embodiment of the present invention.

Referring to FIG. 4, the reconfiguration circuit is formed on a circuit board and includes switching elements 401 and 402 and a switch control unit 403.

The reconfiguration circuit in accordance with the embodiment of the present invention is additionally applied to the multi-band antenna. Referring to FIG. 3, the switching element 401 is added to a plurality of radiating parts, that is, first to third radiating parts 101, 201 and 301, and the switch control unit 403 controls the switching element 401 in response to a control signal inputted based on a frequency band of a transmit signal. Accordingly, the radiating part operating at a corresponding frequency band according to a transmission frequency band is selected in real time, and the transmit signal is sent through a free space.

In addition, the second switching element 402 selects a corresponding radiating part according to a frequency band of a receive signal. That is, the switch control unit 403 controls the switching element 402 to select a radiating part corresponding to the frequency band of the receive signal in real time, in response to a control signal inputted based on the frequency band of the receive signal.

Although it has been described above that the multi-band antenna performs both the transmission and the reception, antennas for transmission and reception may be separately provided according to operating conditions of the antenna.

To verify the utilization of the all-in-one multi-band antenna in accordance with the embodiment of the present invention and show the actual design and the measured results, the first frequency band is defined as the frequency band of the cellular service, the second frequency band is defined as the frequency band of the WCDMA service and Wibro service, and the third frequency band is defined as the frequency band of the WiMAX service.

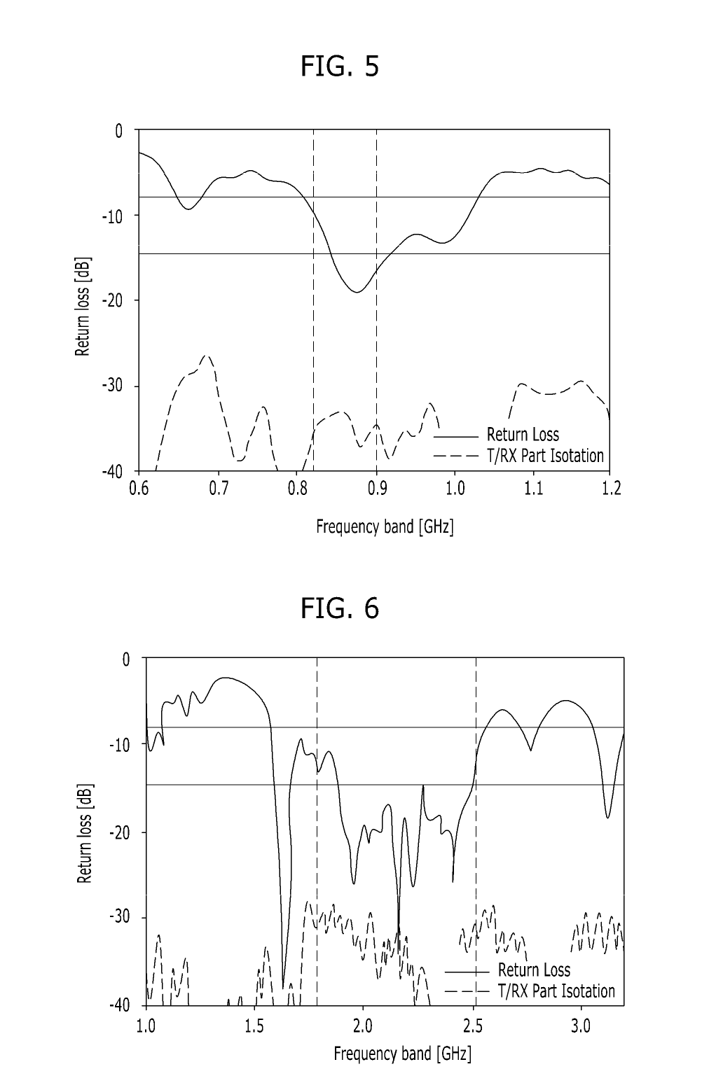

Hereinafter, return loss characteristic at each frequency band in the all-in-one multi-band antenna in accordance with the embodiment of the present invention will be described with reference to FIGS. 5 to 7.

A general antenna technology recommends that a return loss should be −10 dB or less in order for an arbitrary antenna to operate at a given frequency band.

FIG. 5 is a graph showing return loss characteristic at a first frequency band in the all-in-one multi-band antenna in accordance with the embodiment of the present invention.

As illustrated in FIG. 5, a return loss is −10 dB at the first frequency band ranging from 0.8 GHz to 0.94 GHz. That is, the antenna for the first frequency band, which includes the first radiating part 101, the first ground 102, and the first feed line 104, operates normally.

FIG. 6 is a graph showing return loss characteristic at a second frequency band in the all-in-one multi-band antenna in accordance with the embodiment of the present invention.

As illustrated in FIG. 6, a return loss is −10 dB at the second frequency band ranging from 1.6 GHz to 2.6 GHz. That is, the antenna for the second frequency band, which includes the second radiating part 201, the second ground 202, and the second feed line 204, operates normally.

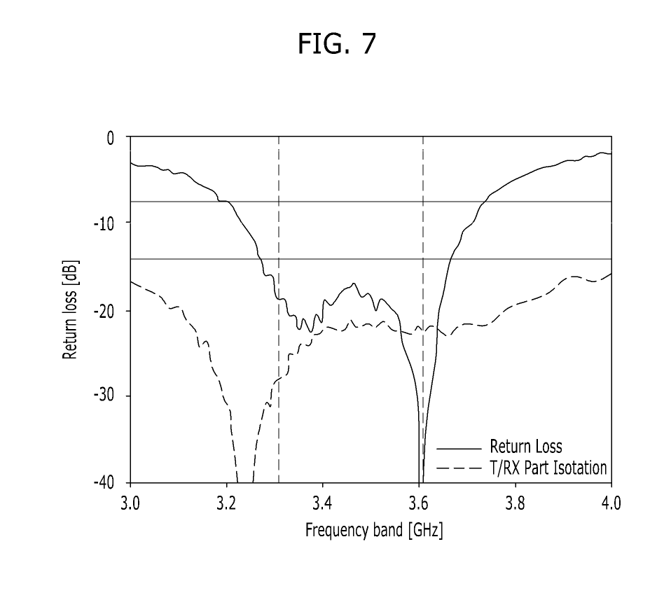

FIG. 7 is a graph showing return loss characteristic at a third frequency band in the all-in-one multi-band antenna in accordance with the embodiment of the present invention.

As illustrated in FIG. 7, a return loss is −10 dB at the third frequency band ranging from 3.3 GHz to 3.6 GHz. That is, the antenna for the third frequency band, which includes the third radiating part 301, the third ground 303, and the third feed line 304, operates normally.

Meanwhile, the antenna in accordance with the embodiment of the present invention may also be configured so that only the third radiating part 301 is provided on the first radiating part 101, without the use of the second radiating part 201.

Specifically, the third radiating part 301 provided with four printed dipole antennas is arranged vertically on the top surface of the first radiating part 101 so that it has a rectangular shape as a whole. Then, the feed line 304 of the third radiating part 301 is coupled to each of the four printed dipole antenna through the feed point 303 thereof. The first radiating part 101 serves as the ground of the third radiating part 301.

The all-in-one antennas operating at multi frequency bands in accordance with the embodiments of the present invention can provide diverse wireless communication and broadcast services through a single antenna at the same time. Thus, several base station antennas can be replaced with a single antenna.

Moreover, the frequency reconfiguration circuit is added to selectively provide a required single, two or three frequencies among a plurality of frequency bands according to the ambient environments where the antenna operates, thereby improving the operation efficiency of communication facilities.

While the present invention has been described with respect to the specific embodiments, it will be apparent to those skilled in the art that various changes and modifications may be made without departing from the spirit and scope of the invention as defined in the following claims.

What is claimed is:

1. An all-in-one multi-band antenna comprising:
a first antenna element configured to operate at a first frequency band, the first antenna element including a first ground, a first radiating part, and a first feed line and a first feed point through which a signal power is applied to the first radiating part; and
a second antenna element configured to operate at a second frequency band, the second antenna element including a second ground, a second radiating part, and a second feed line and a second feed point through which a signal power is applied to the second radiating part,
wherein the second radiating part is provided within a pseudo-cavity formed at a center portion of the first radiating part.

2. The all-in-one multi-band antenna of claim 1, further comprising a third antenna element disposed on the first radiating part and configured to operate at a third frequency band, the third antenna element including a third radiating part, and a third feed line and a third feed point through which a signal power is applied to the third radiating part.

3. The all-in-one multi-band antenna of claim 2, further comprising a reconfiguration circuit configured to select any one of the first to third radiating parts according to frequency bands of transmit/receive signals.

4. The all-in-one multi-band antenna of claim 2, wherein the third antenna element comprises a plurality of third radiating parts, a plurality of third feed lines, and a plurality of feed points corresponding to the third radiating parts.

5. The all-in-one multi-band antenna of claim 4, wherein the third antenna element uses the first radiating part as a ground of the third radiating part.

6. The all-in-one multi-band antenna of claim 5, wherein the plurality of third radiating parts are disposed on the first radiating part so that the second radiating part is positioned within the inside thereof.

7. The all-in-one multi-band antenna of claim 3, wherein the reconfiguration circuit comprises:
a first switching element configured to select a path of the transmit signal;
a second switching element configured to select a path of the receive signal; and
a switch control unit configured to control the first switching element and the second switching element according to the frequency bands of the transmit/receive signals.

8. The all-in-one multi-band antenna of claim 4, wherein the third radiating part is configured with a dipole radiating element which is printed on a dielectric panel made of a dielectric material.

9. An all-in-one multi-band antenna comprising:
a first antenna element configured to operate at a first frequency band, the first antenna element including a first ground, a first radiating part, and a first feed line and a first feed point through which a signal power is applied to the first radiating part; and
a second antenna element configured to operate at a second frequency band, the second antenna element including a second radiating part, and a second feed line and a second feed point through which a signal power is applied to the second radiating part,
wherein the second radiating part is provided on the first radiating part.

10. The all-in-one multi-band antenna of claim 9, further comprising a reconfiguration circuit configured to select one of the first and second radiating parts according to frequency bands of transmit/receive signals.

11. The all-in-one multi-band antenna of claim 9, wherein the second antenna element comprises a plurality of second radiating parts, a plurality of second feed lines, and a plurality of feed points corresponding to the second radiating parts.

12. The all-in-one multi-band antenna of claim 11, wherein the second antenna element uses the first radiating part as a ground of the second radiating part.
